(19) United States
(12) Patent Application Publication
(10) Pub. No.: US 2006/0282987 A1
(43) Pub. Date: Dec. 21, 2006

(54) Door-handle warning lamp for an automobile

(76) Inventors: Pao-Tung Shih, Tainan City (TW); Pao-Chuan Shih, Kaohsiung City (TW); Po-Ming Lin, Kaohsiung City (TW)

Correspondence Address: Pao-Tung Shih, P.O. Box 90, Tainan City, 70499, TW

(21) Appl. No.: 11/261,647

(22) Filed: Oct. 31, 2005

(30) Foreign Application Priority Data
Jun. 10, 2005 (TW) 094209662

(51) Int. Cl. E05B 1/00

(52) U.S. Cl. 16/412

(57) ABSTRACT

A door-handle warning lamp for an automobile includes a door handle having its front side bored with a recessed chamber. A circuit board is installed in the recessed chamber and provided thereon with a plurality of LED lamps. A leak-preventing gasket is fitted in the recessed chamber and a transparent cover is covered on the recessed chamber of the door handle. Thus, when the automobile is to turn leftward or rightward and the left side or the right-side directional lamp is turned on, the warning lamp on the door handle will be lit up at the same time for warning. In addition, when the car door is opened, the door handle warning lamp will also be lit up to warn other cars and pedestrians passing by the left or the right side of the automobile.

### BACKGROUND OF THE INVENTION

1. Field of the Invention

This invention relates to a door-handle warning lamp for an automobile, particularly to one installed in the recessed chamber of the door handle of an automobile. A circuit board is positioned in the recessed chamber of the door handle and provided thereon with a plurality of LED lamps. A leak-preventing gasket is fitted in the recessed chamber and a transparent cover is covered on the recessed chamber of the door handle. Thus, when the automobile changes direction and the left-side or the right-side directional lamp is turned on, the door handle warning lamp at the same side will be lit up synchronously for warning. In addition, even when the car door is opened, the door-handle warning lamp will also be lit up for warning the cars and the pedestrians passing by sideward.

2. Description of the Prior Art

Generally, directional lamps are mostly assembled at the front and the rear side of an automobile for arousing attention of pedestrians or other cars coming from the front and the rear side of the automobile, but pedestrians or other cars passing by the left and the right side of the automobile are unaware that the automobile is going to change direction. For improving this situation, some cars have each rear view mirror additionally installed thereon with a warning directional lamp. However, the light emitted by such a warning directional lamp can only illuminate the front of the automobile but cannot arouse the attention of other cars passing by sideward. In addition, when the driver or the passenger of an automobile is unaware whether there is any car passing sideward and opens the car door abruptly, the car passing by the left or the right side of the automobile will be unable to dodge in time and an accidental collision will inevitably occur.

### SUMMARY OF THE INVENTION

The objective of the invention is to offer a door handle warning lamp for an automobile for upgrading warning effect when the automobile is to turn leftward or rightward and for arousing the attention of other cars and pedestrians passing by.

A main feature of the invention is a recessed chamber bored in the front side of the door handle of an automobile. A circuit board is installed in the recessed chamber and provided thereon with a plurality of LED lamps and electric wires. A leak-preventing gasket is positioned in the recessed chamber and a transparent cover is covered on the recessed chamber of the door handle.

Another feature of the invention is a recessed chamber bored in the rear side of the door handle of an automobile. A circuit board is disposed in the recessed chamber of the door handle and provided thereon with a plurality of LED lamps and electric wires. A leak-preventing gasket is fitted in the recessed chamber and a cover plate is covered on the recessed chamber of the door handle.

### BRIEF DESCRIPTION OF DRAWINGS

This invention will be better understood by referring to the accompanying drawings, wherein:

FIG. 1 is an exploded perspective view of a first preferred embodiment of a door-handle warning lamp for an automobile in the present invention;

FIG. 2 is a perspective view of the first preferred embodiment of the door-handle warning lamp for an automobile in the present invention;

FIG. 3 is a perspective view of the first preferred embodiment of the door-handle warning lamp for an automobile in a using condition when a car is turning rightward in the present invention;

FIG. 4 is a perspective view of the first preferred embodiment of the door-handle warning lamp for an automobile in a using condition when a car is turning leftward in the present invention;

FIG. 5 is a perspective view of the first preferred embodiment of the door-handle warning lamp for an automobile in a using condition when the car door is opened in the present invention;

FIG. 6 is an exploded perspective view of a second preferred embodiment of a door-handle warning lamp for an automobile in the present invention; and

FIG. 7 is a perspective view of the second preferred embodiment of the door-handle warning lamp for an automobile in the present invention.

### DETAILED DESCRIPTION OF THE PREFERRED EMBODIMENT

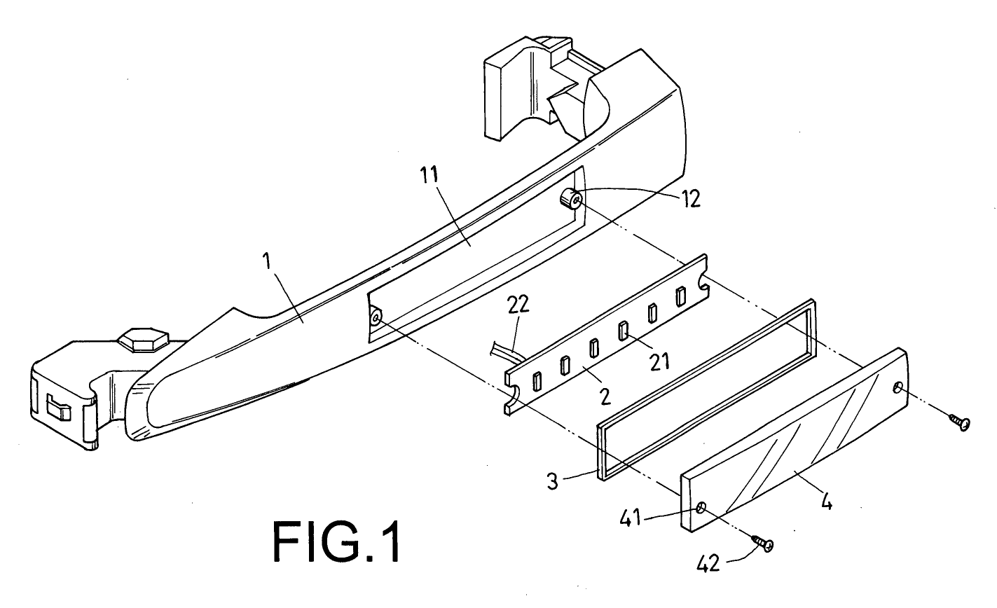

A first preferred embodiment of a door-handle warning lamp for an automobile in the present invention, as shown in FIG. 1, includes a door handle 1, a circuit board 2, a leak-preventing gasket 3 and a transparent cover 4 combined together.

The door handle 1 has its front side formed with a recessed chamber 11 having two female-threaded projections 12 fixed therein. The circuit board 2 positioned in the recessed chamber 11 of the door handle 1 is provided with a plurality of LED lamps 21 and electric wires 22. The leak-preventing gasket 3 is fitted in the recessed chamber 11 of the door handle 1. The transparent cover 4 is covered on the recessed chamber 11 of the door handle 1 and bored with two insert holes 41 respectively having a fastening member inserted therethrough.

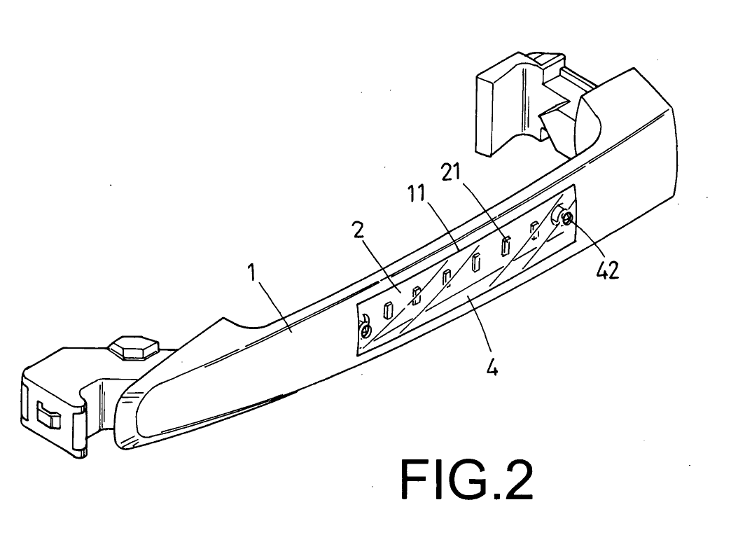

In assembling, as shown in FIGS. 1 and 2, firstly, the circuit board 2 and the leak-preventing gasket 3 are orderly installed in the recessed chamber 11 of the door handle 1, and the electric wires 22 of the circuit board 2 are connected with the electric source of the automobile 5. Next, the transparent cover 4 is covered on the recessed chamber 11 of the door handle 1 and firmly fixed by the fastening members 42 respectively inserted through the insert holes 41 of the transparent cover 4 and the screwed with the female-threaded projections 12 in the recessed chamber 11 to finish assembly of door handle warning lamp.

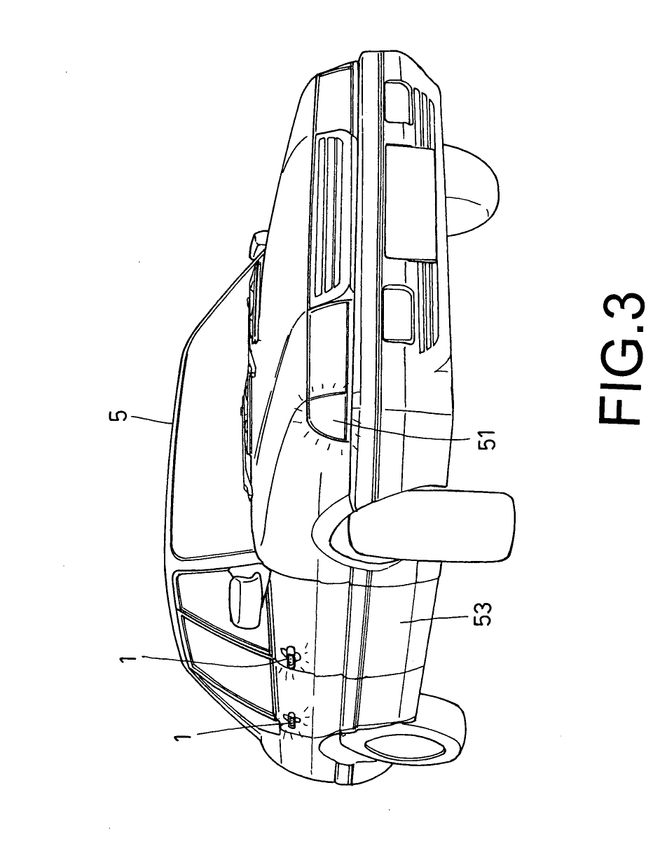

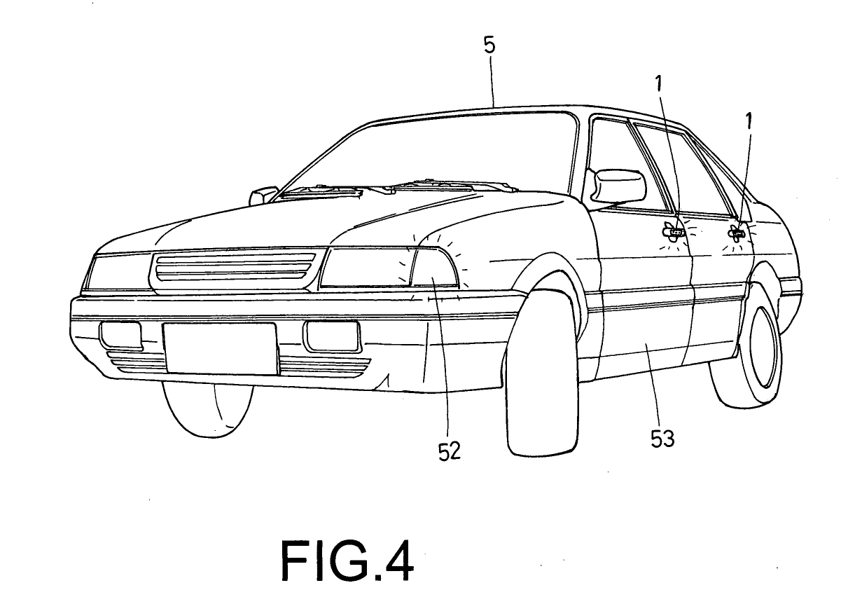

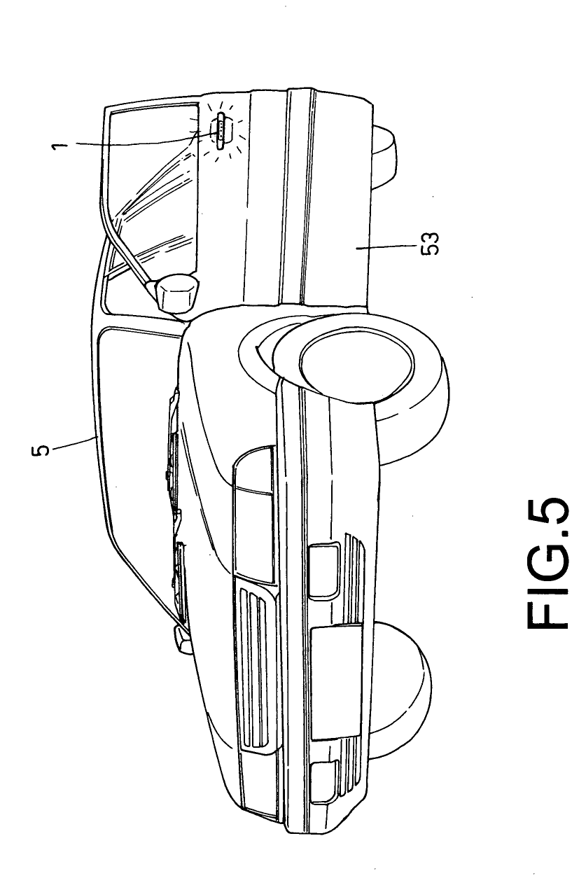

In using, as shown in FIGS. 3, 4 and 5, the door handle 1 with the warning lamp is assembled on the automobile 5 and the electric wires 22 are connected with the electric source of the automobile 5. Thus, when the automobile 5 is to turn rightward and the right-side directional lamp is turned on, the warning lamp on the right-side door handle 1 will be lit up at the same time to arouse the attention of the cars or the pedestrians passing by from the right side of this automobile. When the automobile is to turn leftward and the left-side directional lamp is turned on, the warning lamp on the left-side door handle 1 will be lit up synchronously, as shown in FIG. 4. In addition, when the car door 53 is opened, the warning lamp on the door handle 1 of this car door 53 will shine for arousing the attention of the cars or the pedestrians passing by sideward, able to avoid accidents of collision and especially having excellent warning effect at night.

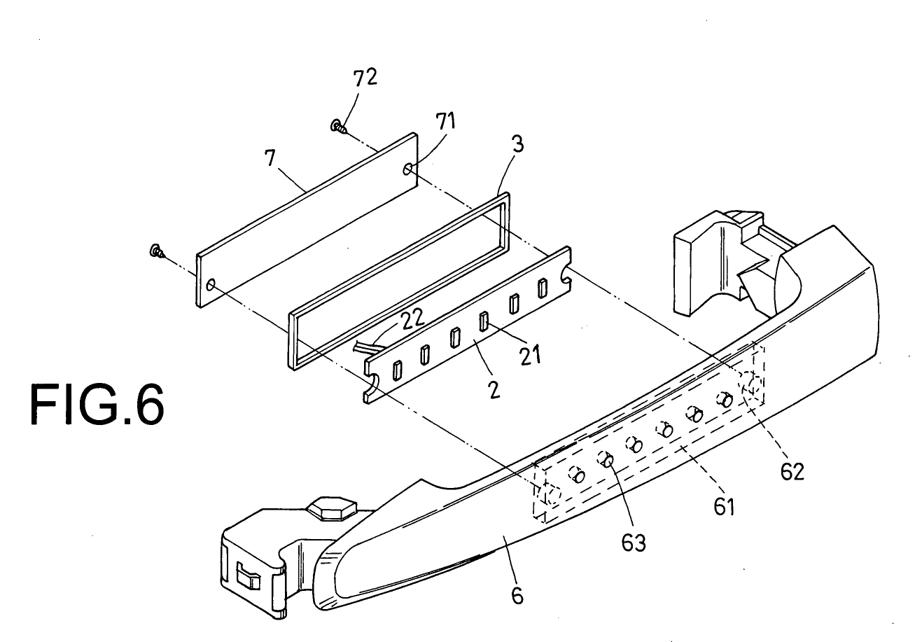

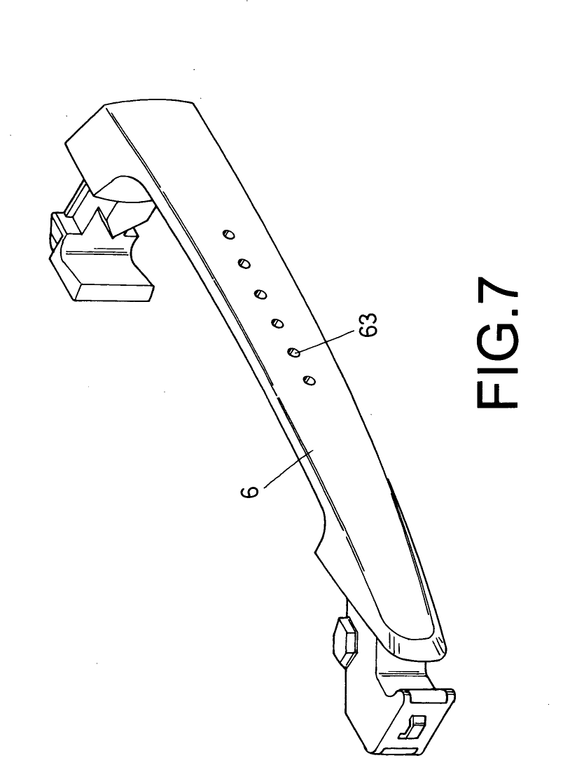

A second preferred embodiment of the door handle warning lamp for an automobile in the present invention, as shown in FIGS. 6 and 7, includes a door handle 6, a circuit board 2, a leak-preventing gasket 3 and a cover plate 7 combined together. The door handle 6 has its rear side formed with a recessed chamber 61 having two female-threaded projections 62 fixed therein and its front side bored with a plurality of light holes 63. The circuit board 2 positioned in the recessed chamber 61 of the door handle 6 is provided thereon with a plurality of LED lamps 21 and electric wires 22. The leak-preventing gasket 3 is fitted in the recessed chamber 61 of the door handle 6. The cover plate 7 is covered on the recessed chamber 61 of the door handle 6 and bored with two insert holes 71 respectively having a locking member 71 inserted therein.

In assembling, the circuit board 2 and the leak-preventing gasket 3 are orderly positioned in the recessed chamber 61 of the door handle 6 and the cover plate 7 is covered on the recessed chamber 61 of the door handle 6, letting the LED lamps 21 on the circuit board 2 respectively aligned to the light holes 63 in the front side of the door handle 6. Thus, light emitted by the LED lamps 21 can shoot outward through the light holes 63 of the door handle 6. In using, when the automobile 5 is to turn leftward or rightward and the left-side directional lamp 51 or the right-side directional lamp 52 is turned on, or when the car door 53 is opened, the warning lamp on the door handle 6 will be lit up at the same time for warning.

While the preferred embodiments of the invention have been described above, it will be recognized and understood that various modifications may be made therein and the appended claims are intended to cover all such modifications that may fall within the spirit and scope of the invention.

I claim:

1. A door handle warning lamp for an automobile comprising a door handle having its front side bored with a recessed chamber, a circuit board installed in said recessed chamber, said circuit board provided thereon with a plurality of LED lamps and electric wires, a leak-preventing gasket fitted in said recessed chamber, a transparent cover covered on said recessed chamber of said door handle.

2. A door handle warning lamp for an automobile comprising a door handle having its rear side bored with a recessed chamber, said door handle having its front side bored with a plurality of light holes, a circuit board installed in said recessed chamber, said circuit board disposed thereon with a plurality of LED lamps and electric wires, a leak-preventing gasket fitted in said recessed chamber, a cover plate mounted on said recessed chamber of said door handle.
